(19) United States
(12) Patent Application Publication
(10) Pub. No.: US 2002/0021260 A1
(43) Pub. Date: Feb. 21, 2002

(54) Multiscreen display apparatus and multiscreen display method

(76) Inventor: Takeya Meguro, Tokyo (JP)

Correspondence Address: JAY H. MAIOLI, Cooper & Dunham LLP, 1185 Avenue of the Americas, New York, NY, 10036, US

(21) Appl. No.: 09/886,431

(22) Filed: Jun. 21, 2001

(30) Foreign Application Priority Data
Jun. 26, 2000 (JP) P2000-191342

(51) Int. Cl. G09G 5/00

(52) U.S. Cl. 345/1.3

(57) ABSTRACT

There is provided a multiscreen display apparatus for determining the size of each screen display area and providing higher quality on screens with a large display area. A multiscreen display apparatus to perform processing to constantly provide good image quality on a desired screen is comprised of a selector to selectively switch the input to the main image or sub-image, a main screen processor to process the main image or the sub-image signal and output a high image quality main screen or sub-screen processing signal, a sub-screen processor to process the sub-image or main image signal and output a low image quality sub-screen or main screen processing signal, a digital processor to perform multiscreen processing by utilizing the main screen or sub-screen processing signal, a selector to selectively switch the digital processing to the main screen or sub-screen processing signal of the digital processor, and a microcomputer to control the switching of the selector.

### BACKGROUND OF THE INVENTION

1. Field of the Invention

The present invention relates to a multiscreen display apparatus and multiscreen display method ideal for multiscreen displays such as in television receivers.

2. Description of the Related Art

In the case of a multiscreen display for television receivers as shown in the multiscreen processing system of the related art in FIG. 1, the signal for the main screen image 51 utilized on the main screen is processed on a main screen processor 53 for the best image quality, and the signal for the sub-image 52 utilized on the other sub-screens is processed on a sub-screen processor 56 having a greater drop in image quality than the main screen processor 53. Therefore, high performance Y (luminance signal) C (chroma signal) separator processing 54, as well as Y (luminance signal)/C (chroma signal) signal processing 55 are performed in the main screen processor 53. However, rather than high performance processing, low performance YC separator processing 57 and Y/C signal processing 58 are performed in the sub-image signal processor 58. In the digital processor 59, the main screen signal from the main screen processor 53 then passes through the double speed converter 60, and the sub-screen signal from the sub-screen processor 56 passes through the converter 61 and multiscreen processing 62 performed.

The difference in the degree of image quality between the main screen and sub-screens was achieved in this way, because the main screen processor 53 performs processing utilized when viewing the main screen on one screen; and the sub-screen processor 56 performs processing utilized for the related sub-screens. In the case of the related art, the sub-screen does not use a processing system having performance equivalent to the main screen due to the fact that the sub-screen is not the screen mainly viewed by the user and from the viewpoint of the television receiver cost. The sub-screen processor 56 therefore had poorer image quality than the main screen processor 53. The settings for each processing system were also fixed within the television receiver, and a specified screen was defined as the main screen, and was determined according to circumstances of the particular television receiver.

However, in the case of multiscreen displays of multiscreen display processing systems in television receivers of the related art, what screen the user views cannot be determined so that even though high image quality is demanded for the screen with the largest display area, the problem arose that high image quality cannot be provided on screens with a large display area since each processing system used fixed settings.

### SUMMARY OF THE INVENTION

The present invention has the object of providing a multiscreen display apparatus for determining the size of each screen display area and providing higher quality on screens with a large display area.

The multiscreen display apparatus of the present invention comprises an input switching means for selectively switching the input of a main image and a plurality of sub-images; a main screen processing means for processing the main image signal or the sub-image signal and outputting a comparatively high quality main screen processing signal or the sub-screen processing signal and; a sub-screen processing means for processing the main image signal or the sub-image signal and outputting a comparatively low quality main screen processing signal or the sub-screen processing signal and; a digital processing means for performing multiscreen processing by utilizing the main screen processing signal or the sub-screen processing signal and; a digital processing switching means for selectively switching the digital processing of the main screen processing signal or the sub-screen processing signal of the digital processing means and; a control means for controlling the input switching means and the digital processing switching means.

Accordingly, the multiscreen display apparatus of the present invention is capable of processing the desired screen on a processing system of constant high image quality by controlling the switching according to an input screen, capable of improving the visual image quality with a simple structure since the sub-screen processing system and the main screen processing system do not require the same level of performance, and also capable of improving image quality by limiting cost increases through use of software.

Further, the multiscreen display apparatus of the present invention is capable of processing the desired screen on a processing system of constant high quality by controlling the switching according to the input instruction screen since the switching by the control means is performed based on entry instructions by the user.

Also, the multiscreen display apparatus of the present invention is capable of processing a screen with the large display area by means of a processing system of constant high quality by controlling the switching according to an input instruction screen since the entry instruction input by the user is an instruction to enlarge the main image or the sub-image.

Still further, the multiscreen display apparatus of the present invention, is capable of processing the desired screen on a processing system of constant high image quality since the desired screen is selected from an electronic program guide by controlling the switching according to the input instruction screen since the sub-image is an electronic program guide and the main image is the optional image specified from the electronic program guide.

The method of displaying a multiscreen according to the present invention comprises an input switching step for selectively switching the input of a main image and a plurality of sub-images; an input step for inputting whether to enlarge the display area of the screen of either the main image or the sub-image, a decision step to decide what display area of the screen of either the main image or the sub-image to enlarge based on the input step; a main screen processing step for performing multiscreen processing and comparatively high quality main screen processing for the screen of the main image, along with performing multiscreen processing and comparatively low quality sub-screen processing for the screen of the sub-image when enlarging the display area of the screen of the main image; and a sub-screen processing step for performing multiscreen processing and comparatively high quality main screen processing for screen of the sub-image, along with performing multiscreen processing and comparatively low quality sub-screen processing for the screen of the main image when enlarging the display area of the screen of the sub-image.

The present invention therefore has the following functions.

First of all, multiscreen processing starts and the input signal is selected. More specifically, the signal of the main image utilized on the main screen and the signal of the sub-images utilized in the other sub-screens are inputted to the input switching means. The input switching means selectively switches the main image signal utilized on the main screen or the sub-image signal utilized in other sub-images, to the main screen processor or the sub-screen processor based on the switching signal from the control means that was input by the switching means.

Next, which screen to enlarge is decided, more specifically, which screen display area to enlarge from either the screen of the main image or the screen of the sub-image is inputted from the input means so that a decision is made to enlarge the screen display area of either the screen of the main image or the screen of the sub-image based on the input of the input means. A decision is made here that an input instruction from the input means was made for displaying an enlarged main screen of one side of the display area.

The input switching means and digital processing switching means are switched and the main screen processor selected for processing the main image signal utilized on the main screen. More specifically, the input switching means is switched so that the main image signal utilized on the main screen is processed on the main screen processor which has the highest image quality, and the sub-image signal utilized on the other sub-screens is processed on a sub-screen processor having image quality lower than the main screen processor.

In the digital processor, the main screen signal from the main screen processor and the sub-screen signal from the sub-screen processor are selectively switched by the switching of the digital processing switching means to display the main screen signal on the left side display area and to display the other sub-screen signals on the right side display area, and multiscreen display processing performed.

In this way, on the output screen, the main screen of comparatively high quality enlarged image is shown as an enlarged image on one side of the display area, and the sub-screens are shown as comparatively low quality small images on the other side of the display area.

### BRIEF DESCRIPTION OF THE DRAWINGS

FIG. 1 is a block diagram showing the multiscreen display processing system of the related art.

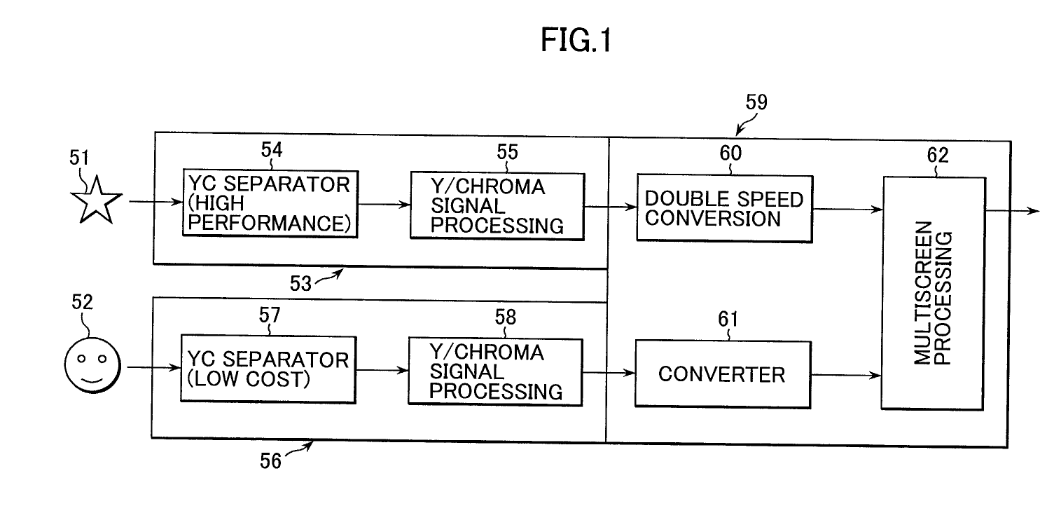

FIG. 2 is a block diagram showing the structure of an adaptive type multiscreen display processing system (when right side of the display area is enlarged).

FIG. 3 is a block diagram showing the structure of an adaptive type multiscreen display processing system (when right side of the display area is enlarged).

FIG. 4 is a block diagram showing the structure of an adaptive type multiscreen display processing system (when left side display area is enlarged for DTV compatibility).

FIG. 5 is a control flow chart showing the operation of the multiscreen display.

### DETAILED DESCRIPTION OF THE PREFERRED EMBODIMENTS

In the multiscreen display device of the embodiment, the user viewing screen on the multiscreen display is determined, and the highest quality processing is performed on the screen mainly viewed by the user. This multiscreen display device is configured to allow viewing at constant high quality on the large display area screen linked to the input instructions of the user so that even if the two processing systems do not have identical high performance, one processing system can be set for high performance and the two processing systems selectively switched.

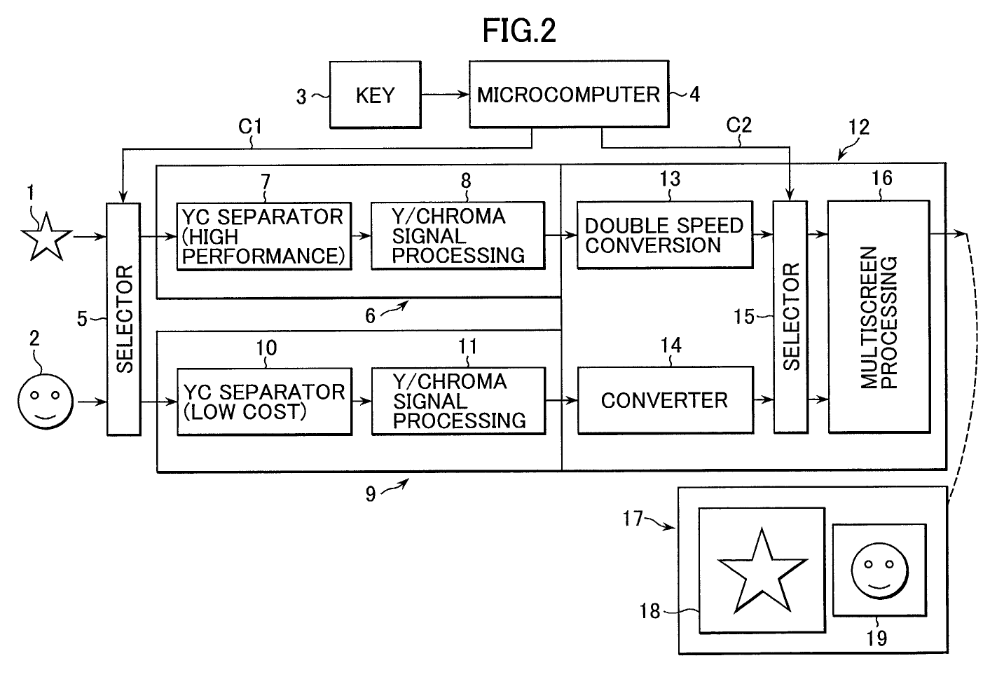

As shown in the adaptive type multiscreen display system in FIG. 2, during a display on another screen of the television receiver, a selector 5 is installed to selectively switch a main image 1 utilized on the main screen or a sub-image 2 signal utilized on other sub-screens, and based on a switching control signal C1 from a microcomputer 4 input by a key 3, the signal of the main image 1 used on the main screen is processed in a main screen processor 6 to have the best image quality, and the signal of the sub-image 2 used on the other sub-screens is processed in a sub-screen processor 9 having image quality lower than the main screen processor 6.

The high performance Y (luminance signal) C (chroma) signal separator processing 7 and the Y (luminance signal)/C (chroma) signal processing 8 are therefore performed in the main screen processor 6. However, rather than high performance, the low performance YC separator processing 10 and the Y/C signal processing 11 are performed in the sub-screen processor 9.

Then, in the digital processor 12, after the main screen signal from the main screen processor 6 passes through double speed conversion 13, the sub-screen signal from the sub-screen processor 9 passes through the converter 14, and a selector 15 selectively switches the main screen signal or other sub-screen signals based on the switching control signal C2 from the microcomputer 4 input by key 3, and multiscreen display processing 16 is performed.

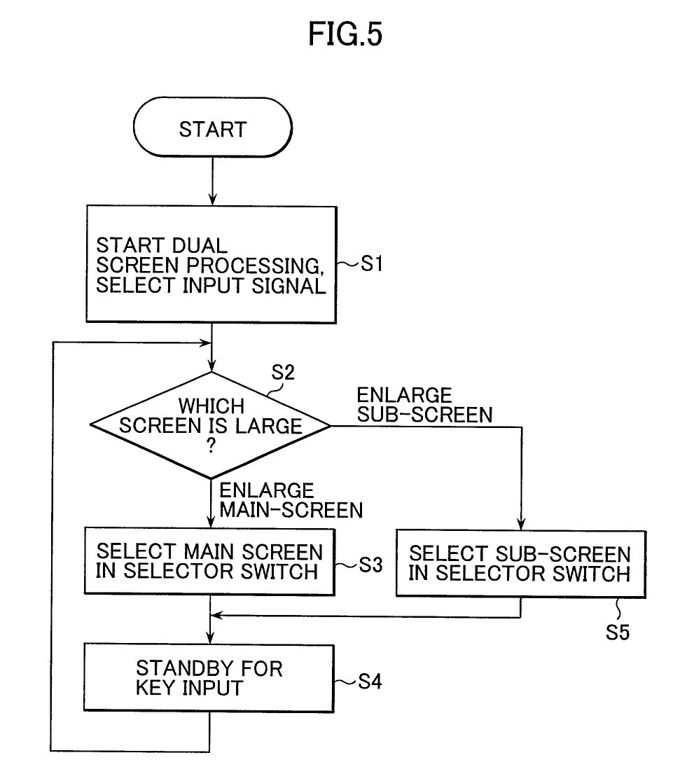

Here, as shown on the multiscreen display processing flowchart in FIG. 5, dual screen processing starts in step S1 and the input signal is selected. More specifically, the signal of the main image 1 utilized on the main screen or the signal of the sub-image 2 utilized on the other sub-screens is inputted to the selector 5. The selector 5 selectively switches the signal of the main image 1 utilized on the main screen or the signal of the sub-image 2 utilized on the other sub-screens to the main screen processor 6 or the sub-screen processor 9, based on a switching control signal C1 from the microcomputer 4 input by the key 3.

In step S2, which screen to enlarge is decided. More specifically, in step S4, either of the screen display areas from either the main image 1 screen or the sub-image 2 screen is inputted by the key 3, so that which screen display area to enlarge from either the main image 1 screen or the sub-image 2 screen is decided based on the key 3 input. A determination is made here in step S4, that an input instruction was made from key 3 to enlarge the left side display area of the main image 1 screen.

In step S3, the selectors 5, 15 are operated (switched) and the main screen processor 6 is selected for processing the signal of the main image 1 utilized on the main screen. More specifically, the selector 5 selects the main screen processor 6 which has the highest image quality, for processing the main image 1 signal utilized on the main screen, and selects the sub-screen processor 9 having image quality inferior to the main screen processor 6, for processing the sub-screen 2 utilized on the other sub-screens.

Then, in the digital processor 12, after the main screen signal from the main screen processor 6 passes through the double speed conversion 13, the sub-screen signal from the sub-screen processor 9 passes through the converter 14. The selector 15 selectively switches the display of the main screen signal to the display area on the left side and the sub-screen signal to the display area on the right side and multiscreen display processing 16 is implemented.

The image 18 of the main screen is in this way enlarged and displayed as a comparatively high quality image on the left side of the display area of the output screen 17. The image 19 of the other sub-screens is displayed reduced in size as a comparatively low quality image on the right side of the display area of the output screen 17.

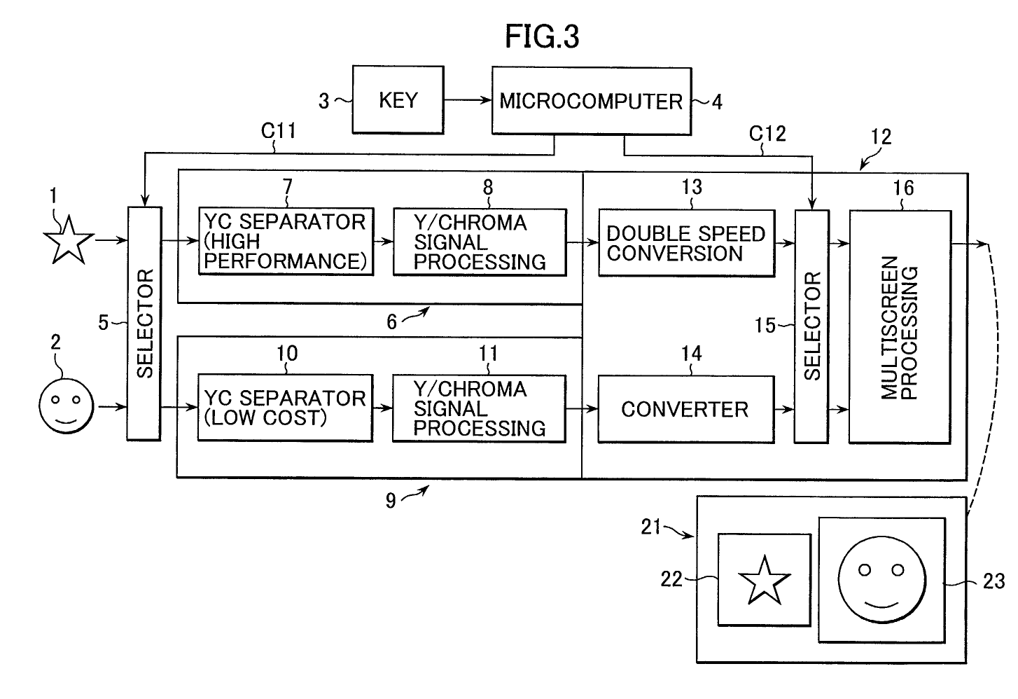

As shown in FIG. 3 in the structure of an adaptive type multiscreen display processing system (when right side of the display area is enlarged), when displaying on other screens of the television receiver, the selector 5 selectively switches the signal of the main image 1 utilized on the main screen or the signal of the sub-image 2 utilized on the other sub-screens, based on a switching control signal C1 from the microcomputer 4 input by the key 3 and the sub-image image 2 signal utilized on the sub-screens is processed in the main screen processor 6 for highest image quality, and the main image 1 signal utilized on the main screen is processed in the sub-screen processor 9 having image quality inferior to the main screen processor 6.

The high performance Y (luminance signal) C (chroma) signal separator processing 7 and the Y (luminance signal)/C (chroma) signal processing 8 are therefore performed in the main screen processor 6. However, rather than high performance, the low performance YC separator processing 10 and the Y/C signal processing 11 are performed in the sub-screen processor 9.

Then, in the digital processor 12, after the main screen signal from the main screen processor 6 passes through double speed conversion 13, the sub-screen signal from the sub-screen processor 9 passes through the converter 14, and a selector 15 selectively switches the main screen signal or other sub-screen signals based on the switching control signal C12 from the microcomputer 4 input by key 3, and multiscreen display processing 16 is performed.

Here, as shown on the multiscreen display processing flowchart in FIG. 5, dual screen processing starts in step S1 and the input signal is selected. More specifically, the signal of the main image 1 utilized on the main screen or the signal of the sub-image 2 utilized on the other sub-screens is inputted to the selector 5. The selector 5 selectively switches the signal of the main image 1 utilized on the main screen or the signal of the sub-image 2 utilized on the other sub-screens to the main screen processor 6 or the sub-screen processor 9, based on a switching control signal C11 from the microcomputer 4 input by the key 3.

In step S2, which screen to enlarge is decided. More specifically, in step S4, either of the screen display areas from either the main image 1 screen or the sub-image 2 screen is inputted by the key 3, so that which screen display area to enlarge from either the main image 1 screen or the sub-image 2 screen is decided based on the key 3 input. A determination is made here in step S4, that an input instruction was made from key 3 so as to enlarge the right side display area of the sub-image 2 screen.

In step S5, the selectors 5, 15 are operated (switched) and the main screen processor 6 is selected for processing the signal of the sub-image 2 utilized on the sub-screen. More specifically, the selector 5 selects the main screen processor 6 which has the highest image quality, for processing the sub-image 2 signal utilized on the sub-screen, and selects the sub-screen processor 9 having image quality inferior to the main screen processor 6, for processing the main image 1 signal utilized on the main screen. Then, in the digital processor 12, after the sub-screen signal from the main screen processor 6 passes through the double speed conversion 13, the main screen signal from the sub-screen processor 9 passes through the converter 14. The selector 15 selectively switches the main screen signal to the display area on the left side and the sub-screen signal to the display area on the right side and multiscreen display processing 16 is implemented.

The image 23 of the sub-screen is in this way enlarged and displayed as a comparatively high quality image on the right side of the display area of the output screen 21. The image 22 of the main screen is displayed reduced in size as a comparatively low quality image on the left side of the display area of the output screen 21.

In the multiscreen display processing system of this type of embodiment, the selectors 5, 15 were added for switching the circuit paths of the main image signal or the sub-image signal based on the switching control signals C1, C2, C11, and C12 from the microcomputer 4 input by the key 3. The difference in image quality appearing in the main screen processor 6 or sub-screen processor 9, is due to the double speed conversion 13 and comparator 14 sections I the YC separator processors 7, 10, and the digital processor 12 so the selectors 5, 15 were installed to control the switching of the circuit paths for processing in these components.

High performance processing is performed in the YC separator processor 7 and the Y/C signal processor 8 since the main screen processor 6 is used during multiscreen processing and single-screen processing. The sub-screen processor 9 is only used during multiscreen processing, so low cost processing is performed rather than high performance processing. The main screen system is also used during single-screen processing so high performance double speed conversion 13 processing is also performed.

As shown in FIG. 2 during multiscreen processing, when the left side display area is enlarged, the main screen system for double speed conversion 13 of the main screen processor 6 and the digital processor 12 of the main screen system is occupied with the processing for the left side of display area for the main image 1. Also, as shown in FIG. 3, when the right side display area is large, the main screen system for double speed conversion 13 of the main screen processor 6 and the digital processor 12 is occupied with the processing for the right side of the sub-image 2 display area.

However, just switching the input image with the selector 5 will also cause a change in the contents shown on the screen, so that switching of the display area is also simultaneously performed in the digital processing circuit with the selector 15. Switching control with the selectors 5, 15 is achieved by operation linked with the microcomputer 4 of the user interface.

Signal processing of the screen with the large display area can be achieved utilizing a constant high performance processing system by switching the processing systems in this way, regardless of the positional relation as seen visually. There is therefore no need for high performance in both processing systems, so a simple system can be configured at a low cost and the visual image quality is improved.

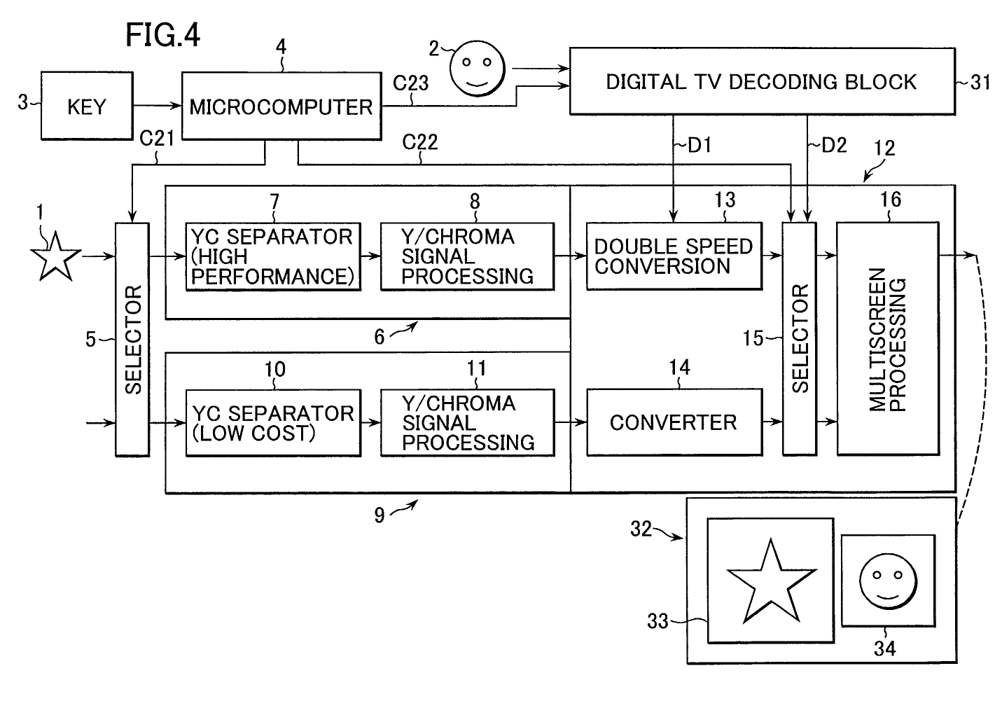

When displaying other screens on the television receiver as shown in FIG. 4 in the structure of an adaptive type multiscreen display processing system (when the left side display area is enlarged for DTV compatibility) , the selector 5 selectively switches the signal of the main image 1 utilized on the main screen or the signal of the sub-image 2 utilized on the other sub-screens, based on a switching control signal C21 from the microcomputer 4 input by the key 3 and main image 1 signal utilized on the main screen is processed in the main screen processor 6 for highest image quality. The sub-screen processor 9 which has image quality inferior to the main screen processor 6 is not used here.

The high performance Y (luminance signal) C (chroma) signal separator processing 7 and the Y (luminance signal)/C (chroma) signal processing 8 are therefore performed in the main screen processor 6.

Based on the switching control signal C23 from the microcomputer 4 input from the key 3, the sub-image signal 2 utilized in the other sub-screens as the digital image input signal is decoded at low image quality by the processing system within the digital TV decoding block 31 which is equivalent to the sub-image processor 9 having image quality lower than the image quality of the main image processor 6.

Then, in the digital processor 12, after the main screen signal from the main screen processor 6 passes through the double speed conversion 13, the main screen signal or the sub-screen signal is selectively switched by the selector 15, based on the switching control signal C22 from the microcomputer 4 input by the key 3, and the multiscreen display processing 16 is implemented. The converter 14 for conversion of the signal from the sub-screen processor 9, is not used here.

The decoding signal for the sub-screen from the digital TV decoding block 31 is supplied as D1 to double speed conversion 13 of the digital processor 12, and as D2 to the selector 15.

Here, dual-screen processing starts in step S1 and the input signal is selected as shown in the control flow chart for the multiscreen display process in FIG. 5. More specifically, the main image 1 signal utilized in the main screen or the sub-image 2 signal utilized in the sub-screen is inputted to the selector 5. The selector 5 selectively switches the main image signal 1 utilized in the main screen, to the main screen processor 6, based on the switching control signal C21 from the microcomputer 4 input by the key 3.

Based on the switching control signal C23 from the microcomputer 4 input from the key 3, the sub-image signal 2 utilized in the other sub-screens as the digital image input signal, is decoded at low image quality by the processing system within the digital TV decoding block 31 which is equivalent to the sub-image processor 9 having image quality lower than the image quality of the main image processor 6.

In step S2, which screen to enlarge is decided. More specifically, in step S4, either of the screen display areas from either the main image 1 screen or the sub-image 2 screen is inputted by the key 3, so that which screen display area to enlarge from either the main image 1 screen or the sub-image 2 screen is decided based on the key 3 input. A determination is made here in step S4, that an input instruction was made from key 3 so as to enlarge the left side of the display area of the main image 1 screen.

In step S3, the selectors 5, 15 are operated (switched) and the main screen processor 6 is selected for processing the signal of the main image 1 utilized on the main screen. More specifically, by the switching of the selector 5, the main image 1 signal utilized on the main screen is processed in the main screen processor 6 which has the highest image quality, and the sub-image 2 signal is decoded by the processing system within the digital TV decoding block 31 equivalent to the sub-screen processor 9 having image quality inferior to the main screen processor 6. Then, in the digital processor 12, after the main image signal from the main screen processor 6 passes through double speed conversion 13, the selector 15 selectively switches the main screen signal to the left side display area and the other sub-screen signal to the right side display area and multiscreen display processing 16 is implemented. The decoding signal for the sub-screen of digital TV decoding block 31 is supplied as D1 to double speed conversion 13 of the digital processor 12, and as D2 to the selector 15. The converter 14 for conversion of the signal from the sub-screen processor 9, is not used here.

The image 34 of the main screen is in this way enlarged and displayed as a comparatively high quality image on the left side of the display area of the output screen 33. The image 34 of the sub-screen is displayed reduced in size as a comparatively low quality image on the right side of the display area of the output screen 32.

Though not shown in the drawing, when displaying other screens on a television receiver, in an adaptive type multiscreen display processing system (when the sub-screen of the right side display area is enlarged for DTV compatibility), the selector 5 selectively switches the main image signal 1 utilized in the main screen, or the sub-image 2 signal utilized on the sub-screen based on the switching control signal C21 from the microcomputer 4 input by the key 3, and the main image signal 1 utilized in the main screen is processed in the sub-screen processor 9 having image quality lower than the main screen processor 6. The main screen processor 6 which has the highest image quality is not used here.

Therefore, rather than high performance, low cost YC separator processing 10 and Y/C signal processing 11 is performed.

Based on the switching control signal C23 from the microcomputer 4 input from the key 3, the sub-image signal 2 utilized in the other sub-screens as the digital image input signal, is subjected to high quality decoding by the processing system within the digital TV decoding block 31 which is equivalent to the main image processor 6.

Then, in the digital processor 12, after the main screen signal from the sub-screen processor 9 passes through the converter 14, the main screen signal or the sub-screen signal is selectively switched by the selector 15, based on the switching control signal C22 from the microcomputer 4 input by the key 3, and the multiscreen display processing 16 is implemented. The converter 13 for conversion of the signal from the main screen processor 6, is not used here.

The sub-screen decoding signal from the digital TV decoding block 31 is supplied as D1 to double speed conversion 13 of the digital processor 12, and as D2 to the selector 15.

Here, dual-screen processing starts in step S1 and the input signal is selected as shown in FIG. 5, in the control flow chart for the multiscreen display process. More specifically, the main image 1 signal utilized in the main screen or the sub-image 2 signal utilized in the sub-screen is inputted to the selector 5. The selector 5 selectively switches the main image signal 1 utilized in the main screen, to the sub-screen processor 9, based on the switching control signal C21 from the microcomputer 4 input by the key 3. The sub-image signal 2 utilized in the other sub-screens as the digital image input signal, is subjected to high quality decoding by the processing system within the digital TV decoding block 31 which is equivalent to the main image processor 6.

In step S2, which screen to enlarge is decided. More specifically, in step S4, either of the screen display areas from either the main image 1 screen or the sub-image 2 screen is inputted by the key 3, so that which screen display area to enlarge from either the main image 1 screen or the sub-image 2 screen is decided based on the key 3 input. A determination is made here in step S4, that an input instruction was made from key 3 so as to enlarge the right side of the display area of the sub-image 2 screen.

In step S5, the selectors 5, 15 are operated (switched) and the sub-screen processor 9 is selected for processing the signal of the main image 1 utilized on the main screen. More specifically, by the switching of the selector 5, the main image 1 signal utilized on the main screen is processed on the sub-screen processor 9 having image quality inferior to the main screen processor 6, and the sub-image signal 2 utilized on the sub-screen is subjected to high quality decoding by the processing system within the digital TV decode block 31 equivalent to the main screen processor 6. In the digital processor 12, after the sub-screen decode signal D1 from the digital TV decode block 31 then passes through double speed conversion 13, the main screen signal from the sub-screen processor 9 passes through the comparator 14, and the selector 15 selectively switches the main screen signal to the left side display area and the other sub-screen signal to the right side display area and multiscreen display processing 16 is implemented. The sub-screen decode signal from the digital TV decoding block 31 is supplied as D1 to double speed conversion 13 of the digital processor 12, and as D2 to the selector 15.

The image 34 of the sub-screen is in this way enlarged and displayed as a comparatively high quality image on the right side of the display area of the output screen 32. The image 33 of the main screen is displayed reduced in size as a comparatively low quality image on the left side of the display area of the output screen 32.

In this way, assuming a digital input signal such as an MPEG2 format 720×480 (SDTV) signal, double speed conversion must be performed so that just as with the digital output signals D1, D2 from the digital TV decoding block 31 as shown in FIG. 4, the main image 1 signal and the sub-image 2 signal of the double speed conversion 13 block are supplied by splitting into two signals to the speed conversion 13 and the selector 15 and so based on the switching control signals C21, C22, C23 from the microcomputer 4 input by the key 3, multiscreen display processing to show images with high image quality on a large display area can be performed just with simple control of the switching.

The above described embodiments, only showed a dual-screen as an example, needless to say however the present invention may also apply to multiscreen display of three or more screens such as sub-screens of an electronic program guide in digital broadcasts for example consisting of some dozens or hundreds of screens, of which one screen is shown as the main screen.

What is claimed is:

1. A multiscreen display apparatus, comprising:
input switching means for selectively switching the input of a main image and a plurality of sub-images;
main screen processing means for processing said main image signal or said sub-image signal and outputting a comparatively high quality main screen processing signal or said sub-screen processing signal;
sub-screen processing means for processing said main image signal or said sub-image signal and outputting a comparatively low quality main screen processing signal or said sub-screen processing signal;
digital processing means for performing multiscreen processing by utilizing said main screen processing signal or said sub-screen processing signal;
digital processing switching means for selectively switching the digital processing of said mainscreen processing signal or said sub-screen processing signal of said digital processing means; and
control means for controlling said input switching means and said digital processing switching means.

2. The multiscreen display apparatus according to claim 1, wherein switching control of said control means is performed based on instructions entered by the user.

3. The multiscreen display apparatus according to claim 2, wherein said instructions entered by the user are instructions to enlarge said main screen or said sub-screen.

4. The multiscreen display apparatus according to claim 3, wherein when said user input instruction is an instruction for enlarging said main image, said main screen processing means processes said main image signal and outputs a comparatively high quality main screen processing signal; and
said sub screen processing means processes said sub-image signal and outputs a comparatively low quality sub screen processing signal.

5. The multiscreen display apparatus according to claim 3, wherein when said user input instruction is an instruction for enlarging said sub-image, said main screen processing means processes said sub-image signal and outputs a comparatively high quality main screen processing signal; and
said sub-screen processing means processes said main image signal and outputs a comparatively low quality sub screen processing signal.

6. The multiscreen display apparatus according to claim 1, wherein said sub-image is an electronic program guide, and said main image is an optional image selected from said electronic program guide.

7. A method of displaying a multiscreen comprising:
an input switching step for selectively switching the input of a main image and a plurality of sub-images;
an input step for inputting whether to enlarge the display area of said screen of either the main image or the sub-image,
a decision step for deciding what display area of said screen of either the main image or the sub-image to enlarge based on said input step;
a main screen processing step for performing multiscreen processing and comparatively high quality main screen processing for the screen of said main image, along with performing multiscreen processing and comparatively low quality sub-screen processing for the screen of said sub-image when enlarging the display area of the screen of said main image; and
a sub-screen processing step for performing multiscreen processing and comparatively high quality main screen processing for the screen of said sub-image, along with performing multiscreen processing and comparatively low quality sub-screen processing for the screen of said main image when enlarging the display area of the screen of said sub-image.
